(19) United States
(12) Patent Application Publication
(10) Pub. No.: US 2026/0337459 A1
(43) Pub. Date: Oct. 29, 2026

(54) RIBBED FLOOR MARKING SYSTEM

(71) Applicant: ShieldMark, Inc., Rocky River, OH (US)

(72) Inventors: Alec Goecke, Rocky River, OH (US); Joe Pampush, Rocky River, OH (US)

(73) Assignee: ShieldMark, Inc., Rocky River, OH (US)

(21) Appl. No.: 19/660,098

(22) Filed: Apr. 27, 2026

Related U.S. Application Data
(60) Provisional application No. 63/794,670, filed on Apr. 25, 2025.

(51) Int. Cl. C09J 7/22

(52) U.S. Cl. CPC C09J 7/22; C09J 2301/122; C09J 2301/16; C09J 2301/302; C09J 2301/312

(57) ABSTRACT

A surface marking tape includes an extrusion having a first surface and an opposed second surface. The first surface includes a plurality of continuous raised ribs extending along a machine direction of the extrusion, providing visual, audible and tactile feedback. The raised ribs are defined by a top portion and valleys between adjacent ribs, with rib tops extending to a height of approximately twice a height of the valleys. A pressure-sensitive adhesive is coupled to the opposed second surface and may be protected by a release liner prior to application of the tape to a surface.

This non-provisional utility application claims priority to U.S. Application No. 63/794,670, filed on Apr. 25, 2025, entitled “Ribbed Floor Marking System”. Each of these applications are incorporated herein by reference in their entirety.

The technical field relates to surface marking tapes, and more particularly to structured surface marking tapes having raised ribs that provide both visual and tactile feedback while exhibiting enhanced tensile strength characteristics.

Surface marking tapes are commonly used to provide visual guidance, safety indicators, and traffic control markings on various surfaces including roadways, walkways, and industrial floors. These tapes typically include a backing material and an adhesive layer for attachment to surfaces. Conventional surface marking tapes often incorporate flat or minimally textured surfaces that provide only visual feedback.

Surface marking tapes are subjected to significant wear and environmental stresses during use, particularly in high-traffic areas or outdoor applications. Many existing tapes suffer from premature wear, deformation, or separation from the surface due to insufficient structural integrity. Additionally, conventional tapes have been found to exhibit inadequate tensile strength, leading to stretching or tearing during installation or use. The application of surface marking tapes in challenging environments, such as areas with heavy vehicle traffic or extreme weather conditions, demands enhanced mechanical properties.

Conventional tapes also lack sufficient surface structure to provide meaningful tactile feedback to pedestrians or vehicle operators. Furthermore, current tapes frequently struggle to maintain their structural integrity and tactile characteristics over extended periods, necessitating frequent replacement and increasing maintenance costs.

These illustrative features mentioned in this disclosure are not intended to limit or define the disclosure, but to provide examples to aid understanding thereof. Additional embodiments are discussed and intended as included. The features, embodiments, and advantages of the present disclosure are better understood when the following is read with reference to the accompanying drawings.

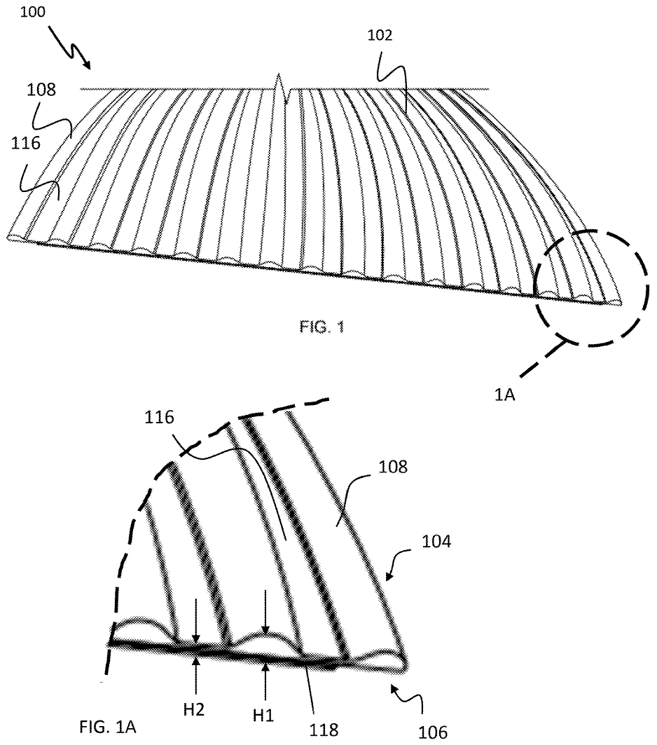

FIG. 1 is a perspective view of a ribbed floor marking system.

FIG. 1A is an enlarged perspective view of a ribbed floor marking system taken from 1A of FIG. 1.

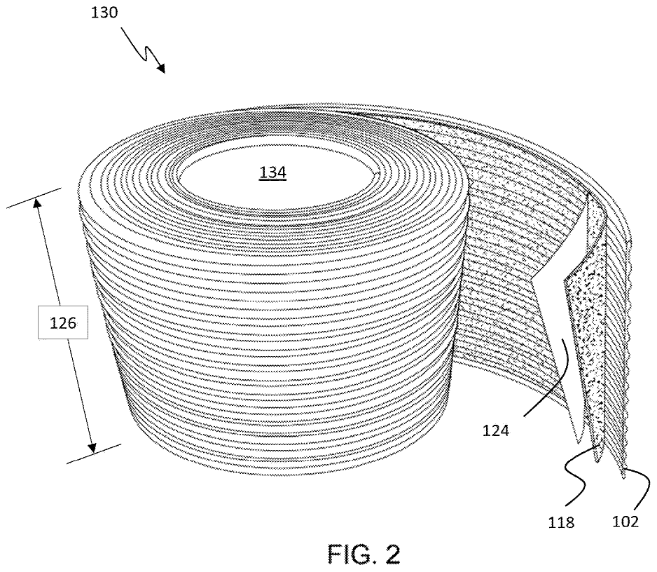

FIG. 2 is a perspective view of a roll of a ribbed floor marking system.

Referring now to FIGS. 1 and 1A, a perspective view of a ribbed marking tape 100 is depicted. The tape 100 is shown as including an extrusion 102 with a first surface 104 and an opposed second surface 106. The first surface 104 includes a plurality of continuous raised ribs 108 extending along a machine direction of the extrusion 102. Raised ribs 108 are separated by valleys 116. The ribs 108 extend to a height H1 of approximately two to three times a height H2 of the valleys 116. Generally, the thickness of the valleys (between the ribs) is about 0.030 mil and the height of the ribs is about 0.092 mil. An adhesive 118 is coupled to the opposed second surface 106 and in embodiments, the adhesive 118 is protected by a release liner 124 (FIG. 2).

The extrusion 102 can be formed from a thermoplastic material. The thermoplastic material can include polyurethane, polyvinyl chloride, and/or polyethylene. In some embodiments, the extrusion 102 can include a retroreflective material to enhance visibility of the surface marking tape 100 in low-light conditions.

The adhesive 118 can comprise a pressure-sensitive adhesive having a thickness of approximately 1 mil to approximately 5 mils. A release liner 124 can be coupled to the adhesive 118 to protect the adhesive 118 prior to application of the surface marking tape 100.

The continuous raised ribs 108 can be positioned at regular intervals across a width 126 of the extrusion 102. The width 126 of the extrusion 102 can range from approximately 2 inches to approximately 6 inches. The ridges 112 and/or valleys 116 together form a textured surface to enhance traction and visibility and tactile feedback to persons or devices traversing the tape 100 when applied to a flooring surface. Moreover, when vehicles traverse the tape 100 audible feedback further identifies crossing the marked area akin to “rumble strips.”

The surface marking tape 100 exhibits specific physical properties that make it particularly suitable for its intended use.

Tensile and elongation were determined on a representative tape of the application and a comparative sample product available from Heskins at https://www.heskins.us/products/ribbed-rubber-non-slip-tape/using the ASTM D3759 Procedure A with modifications on a Tinius Olsen tensile tester. All test samples were conditioned at 73+/−3 degree F and 50+/−5% relative humidity for at least 24 hours prior to testing. All tests were conducted at 73+/−3 degree F and 50+/−5% relative humidity. The modification in sample preparation included using the sample Die A from ASTM D412 which provides a 0.5 in width. The die allows for a wider area (1 inch) of tape to be held in the test grips. The second modification was to decrease the distance between the grips to 3.25 inches from 4.0 inches. The decrease in gap distance better suited the 412 Die A test area.

A sample was die cut and inserted in the instrument's grips with an initial separation of 3.25 inches. The tester was started at a separation rate of 12 inch/minute. At the instant the tape broke, the force and extent of separation were recorded from the digital readout. Five replicates of each tape were tested.

| | Inventive sample | | Comparative sample | |
|---|---|---|---|---|
| | Tensile (max | Break | Tensile (max | Break |
| Replicates | lb/0.5 inch) | Extn (%) | lb/0.5 inch) | Extn (%) |
| 1 | 112.6 | 230.8 | 25.3 | 65.8 |
| 2 | 106.1 | 184.0 | 27.9 | 71.4 |
| 3 | 115.3 | 238.8 | 29.2 | 76.9 |
| 4 | 101.1 | 168.6 | 32.1 | 82.5 |
| 5 | 112.5 | 243.1 | 29.6 | 83.1 |
| Average | 109.5 | 213.0 | 28.8 | 75.9 |
| Std. Deviation | 5.8 | 34.3 | 2.5 | 7.4 |

With respect to tensile strength, plus/minus two standard deviations of the average produces an inventive sample having an average tensile strength of 121.1/97.9 pounds per 0.5 inch more than 95% of the time. Similarly, plus/minus two standard deviations of the average produces a comparative sample having an average tensile strength of 33.8/23.8 pounds per 0.5 inch more than 95% of the time. In other words, the inventive sample has an average tensile strength of three to four times greater than the comparative sample in the vast majority of instances.

With respect to elongation, plus/minus one standard deviation of the average produces an inventive sample having an average elongation of 247.3/178.7 percent about 68% of the time. Similarly, plus/minus one standard deviation of the average produces a comparative sample having an average elongation of 83.3/68.5 percent about 68% of the time. In other words, the inventive sample had an average elongation two to three times greater than the comparative sample more than two-thirds of the time.

With respect to FIG. 2, the surface marking tape 100 can be provided in a roll format 130 where a length ranging between 20 and 50 feet of tape comprising the extrusion 102, the adhesive 118 and release liner 124 is wound onto a cylinder core 134. The cylinder core 134 can have substantially the same or similar width as the width 126 of the tape 100 comprising the extrusion 102, adhesive 118 and release liner 124. The core 134 may be formed from cardboard preferably or other materials having sufficient structural strength to support the roll 130.

The parallel continuous raised ribs 108 in the extrusion 102 provide enhanced visibility, tactile and audible feedback and traction while maintaining the structural integrity of the surface marking tape 100. For example, the continuous raised ribs 108 provide tactile feedback to pedestrians, and tactile and audible feedback to vehicle operators, autonomous vehicles and pedestrians in earshot of the tape.

The configuration of the ridges 112 and valleys 116 (FIG. 1) creates a profile that enhances the tape's performance in various applications, such as road marking, floor marking, or other surface marking applications.

Those skilled in the relevant art will recognize that many changes can be made to the several aspects described, while still obtaining the beneficial results shown and described. It will also be apparent that some of the desired benefits can be obtained by selecting some of the features without utilizing other features. Accordingly, those who work in the art will recognize that many modifications and adaptations are possible and can even be desirable in certain circumstances and are a part of the present disclosure. Thus, the description is provided as illustrative of certain principles and not in limitation thereof.

As used herein, the singular forms “a,” “an” and “the” include plural referents unless the context clearly dictates otherwise. Thus, for example, reference to a “wheel” includes aspects having two or more wheels unless the context clearly indicates otherwise.

Ranges can be expressed herein as from “about” one particular value, and/or to “about” another particular value. When such a range is expressed, another aspect includes from the one particular value and/or to the other particular value. Similarly, when values are expressed as approximations, by use of the antecedent “about,” it will be understood that the particular value forms another aspect. It will be further understood that the endpoints of each of the ranges are significant both in relation to the other endpoint, and independently of the other endpoint.

As used herein, the terms “optional” or “optionally” mean that the subsequently described event or circumstance may or may not occur, and that the description includes instances where said event or circumstance occurs and instances where it does not.

Terms used herein, such as “exemplary” or “exemplified,” are not meant to show preference, but rather to explain that the aspect discussed thereafter is merely one example of the aspect presented.

Additionally, as used herein, relative terms, such as “substantially”, “generally”, “approximately”, and the like, are utilized herein to represent an inherent degree of uncertainty that may be attributed to any quantitative comparison, value, measurement, or other representation. These terms are also utilized herein to represent the degree by which a quantitative representation may vary from a stated reference without

As used herein, “connection” or “connected” or “coupled” means both directly, that is, without other intervening elements or components, and indirectly, that is, with another component or components arranged between the items identified or described as being connected unless specifically described as being directly connected, coupled, etc. To the extent that the term “includes” or “including” is employed in the detailed description or the claims, it is intended to be inclusive in a manner similar to the term “comprising” as that term is interpreted when employed as a transitional word in a claim. Furthermore, to the extent that the term “or” is employed in the claims (e.g., A or B) it is intended to mean “A or B or both.” When the applicants intend to indicate “only A or B but not both” then the term “only A or B but not both” will be employed. Similarly, when the applicants intend to indicate “one and only one” of A, B or C, the applicants will employ the phrase “one and only one.” Thus, use of the term “or” herein is the inclusive, and not the exclusive use. See, Bryan A. Garner, A Dictionary of Modern Legal Usage 624 (2d. Ed. 1995). To the extent that the phrase “one or more of A, B and C” is employed herein, (e.g., storage for one or more of A, B and C) it is intended to convey the set of possibilities A, B, C, AB, AC, BC, and/or ABC (e.g., the storage may store only A, only B, only C, A&B, A&C, B&C, and/or A&B&C). It is not intended to require one of A, one of B, and one of C. When the applicants intend to indicate “at least one of A, at least one of B, and at least one of C,” then the phrasing “at least one of A, at least one of B, and at least one of C” will be employed.

What is claimed is:

1. A surface marking tape comprising:
an extrusion comprising a first surface and an opposed second surface, the first surface comprising a plurality of continuous raised ribs extending along a machine direction of the extrusion, the raised ribs defining:
ridges at a top portion of each raised rib; and
valleys positioned between adjacent raised ribs;
wherein the ridges extend to a height of approximately twice a height of the valleys; and
an adhesive layer coupled to the opposed second surface;
wherein the surface marking tape exhibits a tensile strength at yield of approximately 97 pounds to approximately 121 pounds per half-inch width in the machine direction when tested according to ASTM D3759 Procedure A modified to include testing a sample prepared with die A from ASTM D412 providing a portion with a width of 0.5 inches.

2. The surface marking tape of claim 1 wherein the extrusion comprises a thermoplastic material.

3. The surface marking tape of claim 2 wherein the thermoplastic material comprises polyurethane, polyvinyl chloride, and/or polyethylene.

4. The surface marking tape of claim 1 wherein the adhesive layer comprises a pressure-sensitive adhesive.

5. The surface marking tape of claim 1 wherein between 20 to 50 feet of tape is wound onto a cylinder core.

6. A surface marking tape comprising:
an extrusion comprising a first surface and an opposed second surface, the first surface comprising:
a plurality of parallel continuous raised ribs extending along a machine direction of the extrusion;
ridges defined at a top portion of each raised rib; and
valleys defined between adjacent raised ribs;
wherein the ridges extend to a height of approximately twice a height of the valleys;
a pressure-sensitive adhesive layer coupled to the opposed second surface; and
wherein the surface marking tape exhibits a tensile strength at yield of approximately 97 pounds to approximately 121 pounds per half-inch width in the machine direction when tested according to ASTM D3759 Procedure A modified to include testing a sample prepared with die A from ASTM D412 providing a portion with a width of 0.5 inches.

7. The surface marking tape of claim 6 wherein the ridges comprise a textured surface.

8. The surface marking tape of claim 6 wherein the valleys comprise a textured surface.

9. The surface marking tape of claim 6 wherein the extrusion comprises a width of approximately 2 inches to approximately 6 inches.

10. The surface marking tape of claim 6 wherein the continuous raised ribs are positioned at regular intervals across a width of the extrusion.

11. The surface marking tape of claim 6 wherein the pressure-sensitive adhesive layer comprises a thickness of approximately 1 mil to approximately 5 mils.

12. The surface marking tape of claim 6 comprising a release liner coupled to the pressure-sensitive adhesive layer.

13. The surface marking tape of claim 6 wherein the extrusion comprises a retroreflective material.

14. The surface marking tape of claim 6 wherein a length ranging between 20 and 50 feet of tape is wound onto a cylinder core of substantially the width of the extrusion.
